(19) United States
(12) Patent Application Publication
(10) Pub. No.: US 2008/0190525 A1
(43) Pub. Date: Aug. 14, 2008

(54) Inorganic nitrate-hydrogen peroxide adducts and methods for their preparation

(76) Inventor: Kerry Lee Wagaman, Bryantown, MD (US)

Correspondence Address: DENNISON, SCHULTZ & MACDONALD, 1727 KING STREET, SUITE 105, ALEXANDRIA, VA, 22314, US

(21) Appl. No.: 11/704,994

(22) Filed: Feb. 12, 2007

(51) Int. Cl. F42B 4/00; C01B 15/01; C01C 1/00

(52) U.S. Cl. 149/45; 423/352; 423/385

(57) ABSTRACT

A substantially anhydrous solid or liquid chemical adduct formed by reacting hydrogen peroxide, and a compound selected from the group consisting of sodium nitrate, potassium nitrate, ammonium nitrate, ammonium dinitramide and mixtures thereof.

### BACKGROUND OF THE INVENTION

This invention is directed to novel inorganic poly-peroxidates, as well as chemical synthesis methods for their preparation, and their applicability to the manufacture of Low Water Content Hydrogen Peroxide (LWHP), containing 2 to 50 wt % water and also to Vapor Phase Hydrogen Peroxide (VPHP), containing 0 to 30 wt % water.

Laboratory researchers and industrial chemical processors have been limited as to the availability of solid and liquid compounds having hydrogen peroxide functional reactant groups, also referred to as peroxidates, available for chemical reactions. Hydrogen peroxide is commercially available as an aqueous solution in up to 70 weight percent concentrations. High concentration (low water content) hydrogen peroxide, such as 70% to 98% by weight, is classified as an explosive oxidizer by the US Department of Transportation. The presence of increasing amounts of water can reduce the chemical reactivity; this reactivity can be experimentally determined by comparing aqueous oxidizers' relative reduction-oxidation (REDOX) potential. Increasing the water content will lower the chemical reactivity and may increase the chemical processing steps to remove the residual water from the end product.

Chemical reactivity of hydrogen peroxide also makes possible its use as a fungicide, bactericide, and sporacide. The presence of water reduces the efficacy of hydrogen peroxide for these purposes. For some reactions/applications, it is desirable to further reduce the water content of LWHP to produce even lower water content HP liquid or even its anhydrous vapor.

Those engaged in “rocket science” prefer lower water content oxidizers because water reduces the energy content of the formulated propellants, explosives, and pyrotechnics (PEP's). Even more preferable are anhydrous solid or liquid oxidizers, providing formulators can overcome the associated safety, storage, and handling problems. Therefore, it is desired to develop alternative families of easily-synthesized, new, inexpensive, environmentally-friendly energetic, anhydrous solid and/or liquid oxidizer chemical compounds, which are improvements over prior art families of energy-producing, water-based, liquid oxidizers, such as PERSOLs, OXSOLs, and ANNAs.

In addition, there is substantial concern over chlorinated exhaust gases and toxic perchlorate discharges into waterways and into food chain. Therefore, chemical manufacturers, PEP formulators, biodecontamination scientists, environmentalists, and other scientists and engineers have an interest in the manufacture, availability and applications of LWHP, anhydrous solid and liquid peroxidates, and vapor phase hydrogen peroxide.

Energetic materials formulators have been limited as to the solid and liquid oxidizers available. The large scale, Russian development of ammonium dinitramide (ADN) and its alkali and its metallic nitramide salts has led to interest in developing non-Russian sources for these oxidizers, and energetic formulations using these nitramide oxidizer salts, as well as alternative liquid or solid oxidizers. Prior to the synthesis of ADN, formulators had available primarily the following oxidizers:
Ammonium Nitrate (AN)
Ammonium Perchlorate (AP)
Hydroxylamine Nitrate (HAN)
Hydroxylamine Perchlorate (HAP)
Potassium Nitrate (KN)
Sodium Nitrate (SN)
Hydrogen Peroxide (HP)
Alkali and metallic nitrates, chlorates, and perchlorates salts.

Potential applications for anhydrous solid and liquid oxidizers are as oxidizer ingredients in energetic formulations or enhanced hydrogen peroxide (HP) chemical reactants. Further, thermal and/or vacuum and/or catalytic treatment of solid, liquid, or aqueous PERSOL, inorganic nitrate-peroxidates will produce breatheable oxygen and/or anhydrous or low water content hydrogen peroxide (LWHP) or vapor phase hydrogen peroxide (VPHP) to be used as chemical reactants (epoxidations, hydroxylations, etc.), including bio-decontaminations. The anhydrous solid and liquid inorganic peroxidates can be used as oxidizer ingredients in propellant, explosive, and pyrotechnic (PEP) formulations as oxidizer replacements for chlorates, perchlorates, and other solid or liquid oxidizers, and are inexpensive, energetic and contain no chlorinated ingredients or exhaust products, and produce no toxic perchlorate or chlorate pollution.

Uses for such materials include medical equipment sterilization, perchlorate and/or other oxidizer ingredient replacement in propellants, explosives and pyrotechnics (PEPs) formulations,

### SUMMARY OF THE INVENTION

The invention is thus directed to a substantially anhydrous solid or liquid chemical adduct comprising hydrogen peroxide and nitrate selected from the group consisting of sodium nitrate, potassium nitrate, ammonium nitrate and mixtures thereof. The adduct may contain, for example, by weight, 44% to 70.2% ammonium nitrate and 56% to 29.8% hydrogen peroxide, 49.8% to 74.8% potassium nitrate and 50.2% to 25.2% hydrogen peroxide, or 45.5% to 71.4% sodium nitrate and 54.5 to 28.6% hydrogen peroxide, and may further comprise a surfactant or a stabilizer.

The invention is further directed to a method for forming a substantially anhydrous solid or liquid chemical adduct, comprising the steps of providing a nitrate selected from the group consisting of sodium nitrate, potassium nitrate and mixtures thereof, and reacting the nitrate compound with the hydrogen peroxide to form the adduct. Heat and/or vacuum may be applied to the adduct to synthesize a distillate of aqueous or anhydrous hydrogen peroxide and a still pot bottoms of said substantially anhydrous adduct, or spray drying or freeze crystallization and/or vacuum may be applied to the adduct to synthesize a distillate or filtrate of aqueous hydrogen peroxide and a still pot bottoms or a filter cake of said substantially anhydrous adduct.

The chemical synthesis methods disclosed in this application are also applicable to the manufacture of other inorganic or organic peroxidates, where the commercially-desirable, non-peroxidate functional group may be sodium or potassium carbonate, sodium or potassium bicarbonate, urea, ammonium dinitramide (“ADN”) or other desirable functional groups. Mono- or di-peroxidates or tri-peroxidates of these anhydrous poly-peroxidates may be slurries and/or liquids.

The adduct produced by the method of the invention may be treated by column chromatograhy to synthesize aqueous hydrogen peroxide, and a solvent eluent which upon evaporation of the solvent produces said substantially anhydrous adduct, and heat and/or vacuum may be applied to the substantially anhydrous adduct to synthesize anhydrous vapor phase hydrogen peroxide (VPHP).

Novel anhydrous solid or liquid, covalent-bonded chemical adducts are formed from the chemical reaction of hydrogen peroxide and an inorganic nitrate compound of ammonium nitrate (AN), sodium nitrate (SN), potassium nitrate (KN), ammonium dinitramide or combinations thereof. These chemical adducts are referred to herein as peroxidates and persalts. They may be used an oxidizers in a large number of applications, such as an energetic material formulations including propellants, explosives, and pyrotechnics. The chemical synthesis of these adducts can also produce Low Water content Liquid hydrogen peroxide, containing 2 to 50% water (LWHP), vapor phase hydrogen peroxide (VPHP) containing 0 to 30% water, and anhydrous vapor hydrogen peroxide (VHP).

Inorganic nitrate-hydrogen peroxide adducts are covalently bonded molecules of hydrogen peroxide, bonded to one or more inorganic nitrate salt and/or ADN molecules, which form unique families of inexpensive, environmentally-friendly, solid or liquid oxidizers, having increased chemical reactivity for applications in agriculture, industrial chemical manufacture, energetic formulation manufacture, or for manufacture of vapor Phase Hydrogen Peroxide (VPHP), generation or manufacture of low water content (50% to 98%) hydrogen peroxide, or breathable oxygen generation.

These peroxidate adducts can also be synthesized and used as anhydrous peroxidate solid adducts or as anhydrous peroxidate liquid adducts. These inorganic nitrate peroxidates, i.e., the inorganic nitrate-hydrogen peroxide chemical adducts, dissociate to some extent in certain solvents, e.g., water. These inorganic nitrate-hydrogen peroxide chemical adducts can be prepared by various chemical processes with aqueous or concentrated hydrogen peroxide, or with hydrogen peroxide vapor.

Initial reactant solutions used in the practice of the method of the invention are preferably anhydrous alkali nitrates, or secondarily, commercially-available concentrated aqueous alkali nitrates, available commercially in heated tank cars of up to 85% alkali nitrate content. Less desirably, because of the increased dried alkali nitrate cost, the compounds of the invention may be made by dissolving anhydrous, solid alkali nitrates, ammonium nitrate, potassium nitrate, sodium nitrate, or ammonium dinitramide in the chosen solvent, preferably water, or most preferably into commercially-available concentrated 30% aqueous hydrogen peroxide, or still more preferably 50% to 70% aqueous hydrogen peroxide.

Anhydrous PERSOLs, nitrate-peroxidate adducts, will crystallize or form liquids in definite molar ratios of inorganic nitrate salt to hydrogen peroxide, the most preferred ratio being 1:1, although the liquid 1:2 adducts and other molar ratios of anhydrous chemical adducts or blends thereof can form; the low, e.g. 1:1, molar ratios will be solids, with better thermal stability than the 1:2 or higher molar ratios. Admixtures of one or more nitrate peroxidates may be desirable to obtain more end-products with more desirable physical or chemical properties.

### BRIEF DESCRIPTION OF THE DRAWINGS

FIGS. 1a and 1b are graphs of the theoretical performance of oxidizers, including the oxidizers of the invention shown in FIG. 1b;

FIG. 2 is a schematic diagram of equipment used for preparing peroxidates according to the invention;

FIGS. 3a and 3b are thermogravimetric analyses of ammonium nitrate and ammonium nitrate/H₂O₂ complex, respectively;

FIGS. 3c-3e are differential scanning calorimetric analyses of ammonium nitrate, ammonium nitrate/70% H₂O₂ complex, and ammonium nitrate/35% H₂O₂ complex, respectively.

FIG. 4 is a graph of molar ratio of ammonium nitrate/H₂O₂ complex vs. % water recovered for the synthesis of the ammonium nitrate/H₂O₂ complex;

FIG. 5 is a condensate analysis graph for the synthesis of the ammonium nitrate/H₂O₂ complex;

FIG. 6a is a differential scanning calorimetry analysis is a potassium nitrate/H₂O₂ complex;

FIG. 6b is a graph of thermogravimetric analysis of a potassium nitrate/H₂O₂ complex;

FIG. 7a is a graph of crystallization point vs. weight fraction of sodium nitrate in 3% H₂O₂;

FIG. 7b is a graph of crystallization point of ammonium nitrate in 3% and 35% hydrogen peroxide;

FIG. 7c is a graph of crystallization point vs. weight fraction of potassium nitrate in 3% H₂O₂; and

FIGS. 8a and 8b are graphs of relative REDOX potential vs. % hydrogen peroxide for aqueous solutions of ammonium nitrate adduct and potassium nitrate adduct, respectively, and FIG. 8c is a corresponding graph for hydrogen peroxide without a nitrate salt.

### DETAILED DESCRIPTION OF THE INVENTION

Ammonium nitrate, potassium nitrate, sodium nitrate or ammonium dinitramide is reacted with hydrogen peroxide for the preparation and characterization of anhydrous inorganic nitrate and ADN-peroxidates, known as peroxidate adducts, as well as LWHP, and VPHP. These peroxidate adduct oxidizers are bimolecular, covalent combinations of hydrogen peroxide and one or more solid oxidizers. Crystallization point values, relative REDOX values, thermal analyses, and other analyses show unique and unpredictable physical and chemical properties for these compounds, phenomena attributable to covalent bond interactions of the adducts. Residual water may lead to the formation of the hydrates of the peroxidate adducts, referred to as hydroperoxidates. Similarly formed are chemical peroxidate adducts between base molecule, alkali carbonates or organic chemical compounds, such as urea, which have been documented to contain one to four peroxidate molecules for every base molecule. DSCs, TGAs, TLCs with Starch-KI visualization, column chromatography, off-gassing analyses, permanganate titrimetric analyses, and vapor-condensate analysis during adduct synthesis have been used to verify the existence of chemically and thermally-stable solid and liquid peroxidate oxidizers, and their aqueous solution chemical intermediates. Relative REDOX values show REDOX enhancement compared to the corresponding aqueous hydrogen peroxide. Reactions with these enhanced peroxidate adducts will consume the reactant in hydroxylations, epoxidations, etc; addition of makeup concentrated hydrogen peroxide will rejuvenate the spent inorganic nitrate peroxidate.

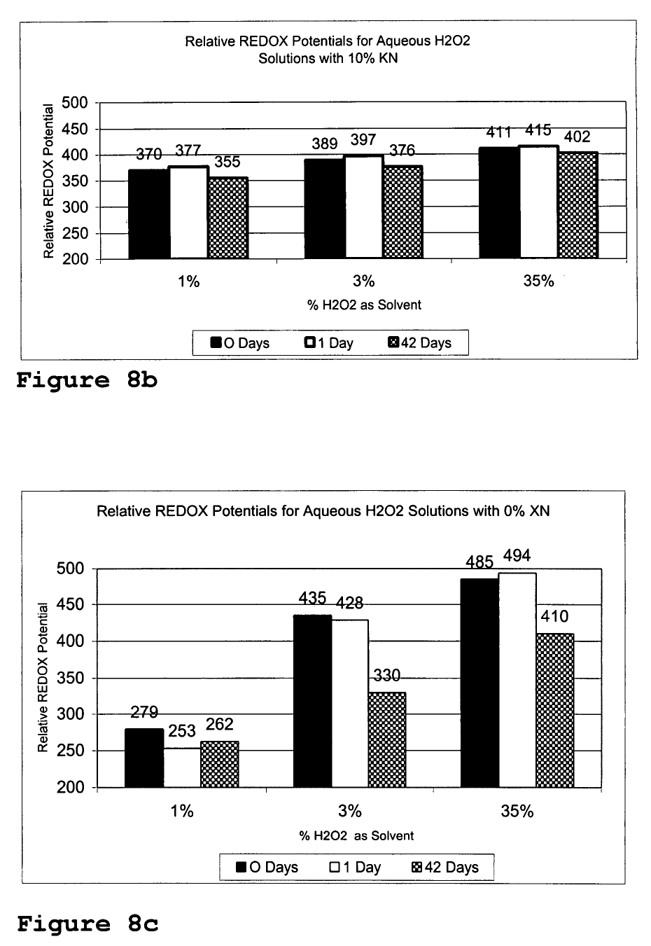

Reactions with these enhanced peroxidate adducts will consume the hydrogen peroxide group reactant in hydroxylations, epoxidations, etc; However, as is shown in the experimental relative REDOX data, FIG. 8, addition of replacement concentrated hydrogen peroxide will rejuvenate the spent inorganic nitrate peroxidate's reactivity. Environmentally, this is desirable, since the base nitrate salt is recycled to enhance this hydrogen peroxide for additional reactions.

These anhydrous liquid or solid peroxidates can be prepared by admixing or crystallization from an aqueous solution of the inorganic salt and hydrogen peroxide. The most stable chemical form is the is the 1:1 molar adduct of inorganic nitrate and hydrogen peroxide. Analogous chemical adducts having 2 and 4 moles of hydrogen peroxide per mole of urea have been reported and have been synthesized and sold commercially. The 1:1 adduct is preferred for use in the practice of this invention for non-defense related commercial applications because of the inherent improved chemical stability of lower molar ratio chemical adducts. Mixtures of the various adducts can also be blended or synthesized. Additives such as a metal chelating agent, e.g. EDTA, may be added to improve chemical stability and therefore, the product's shelf life, based on chelation of metal impurities present which would act acting as degradation catalysts.

These inorganic nitrate peroxidates, PERSOLs, can be applied directly or as a synergistic blend as a biocide or chemical reactant. Thermal treatment of these inorganic nitrate peroxidates, with or without vacuum, can be used to produce vapor phase hydrogen peroxide, useful as an enhanced HP chemical reactant for manufacturing chemicals, bioremediation, etc.

The invention provides for novel, anhydrous, solid or liquid, inorganic nitrate-peroxidate chemical adducts, also referred to herein as XNPERs, composed of one or more chemical adducts or mixtures of one or more inorganic nitrate salts (ammonium nitrate (AN) or potassium nitrate (KN) or sodium nitrate (SN) or ammonium dinitramide (“ADN”) and hydrogen peroxide, whose peroxidate adducts are referred to herein respectively as ANPER, KNPER, SNPER, and ADPER.

Additives such as surfactants, e.g., soaps and synthetic surfactants are often either anionic, such as alkyl benzene sulfonates or alcohol sulfates, or nonionic, such as alcohol ethoxylates. These surfactants reduce the droplet size and increase the wetting ability of the aqueous peroxidates during spray drying or chemical reactions, and biodecontaminations.

These peroxidates are useful in such diverse applications as manufacture of anhydrous or of low water content hydrogen peroxide, biocides (sporacides, bactericides, fungicides, viruscides, sporacides, etc., solid or liquid oxidizer ingredients for propellants, explosives or pyrotechnics (PEPs) formulations or fuel cells, and gas generator applications for breathable oxygen or VPHP reactions.

Chemical adducts of the invention provide compositions that are inexpensive, easily-manufactured, environmentally-friendly, “GRAS” (Generally Regarded As Safe) readily-transportable and storable.

Water removal to form the desired liquid, slurry or solid peroxidates may be done commercially using vacuum-thermal evaporation, freeze-drying, freeze-crystallization, column chromatography, etc. In the case of the water-nitrate-peroxide mixture, the removal of water by various engineering processes results in progressively higher concentrations of the inorganic nitrate-peroxidate compound and hydrogen peroxide in the remaining water until at some point the inorganic nitrate compound-hydrogen peroxide liquid or slurry or solid chemical adduct mixture forms. The temperature of this processing method can vary from very cold to very warm, from freeze crystallization to column chromatography to thermal distillation.

The crystallization point is the temperature during a mixture's cool down at which the first crystals are observed in this mixture. Upon further cool down, an additional crystallization is observed, and when the mixture is slowly warmed, the temperature at which the crystals are no longer observed is referred to as the freezing point. Crystallization point data are useful in the development of syntheses of these solid XNPERs by freeze concentration processing.

As noted above, one or more stabilizers and/or chelating agents may be blended into the chemical adduct composition for increased storage capabilities and chemical compatibility. Additives such as a metal chelating agent, e.g., EDTA (ethylene diamine tetracetic acid) may be added to improve the chemical stability and therefore shelf life time by chelating metal impurities present, which would act as peroxide degradation catalysts. Additional suitable stabilizers are described in U.S. Pat. No. 3,629,331 to Kabacoff et al., U.S. Pat. No. 3,912,490 to Griffith, and U.S. Pat. No. 4,155,738 to Boghosian, and the disclosures of these references are incorporated herein by reference with regard to stabilizers. Preferred stabilizers include polyaminocarboxylate (e.g., EDTA), polyphosphonate (e.g., DTPA) and urea, with EDTA preferred. Preferably the stabilizers, when used, are present in amounts of from about 1% or less, with amounts of from about 0.001% to about 0.1% most preferred.

Additionally, surfactants may be added to these mixtures to reduce the droplet sizes of sprayed solutions, and to improve the wettability of plants or soil treated or in other defense or commercial applications with these liquids or slurries. A liquid or solid fuel such as an alcohol or other organic chemical compound may be also added to make these liquids into propellants, explosives, pyrotechnics or other energetic mixture.

Both vapor phase and low water hydrogen peroxide have commercial and military applications in pyrotechnic compositions, as well as chemical reactions, including epoxidations and hydroxylations, and have biocidal efficacy. The presence of water is detrimental in these applications and in many applications must be minimized. Premixing anhydrous ammonium nitrate with aqueous hydrogen peroxide to form a covalent nitrate-peroxidate will lower the water content of the distillate, and form a distillate of low water or vapor phase hydrogen peroxide.

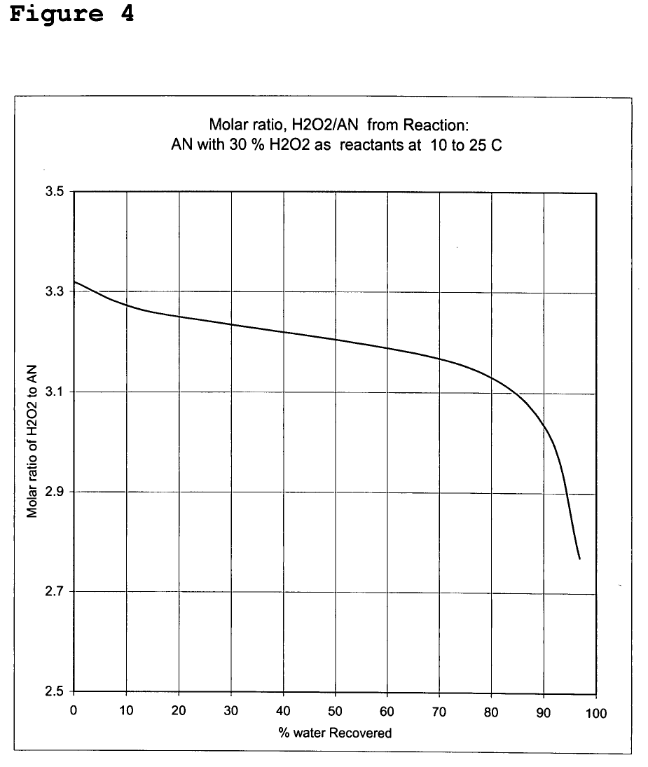

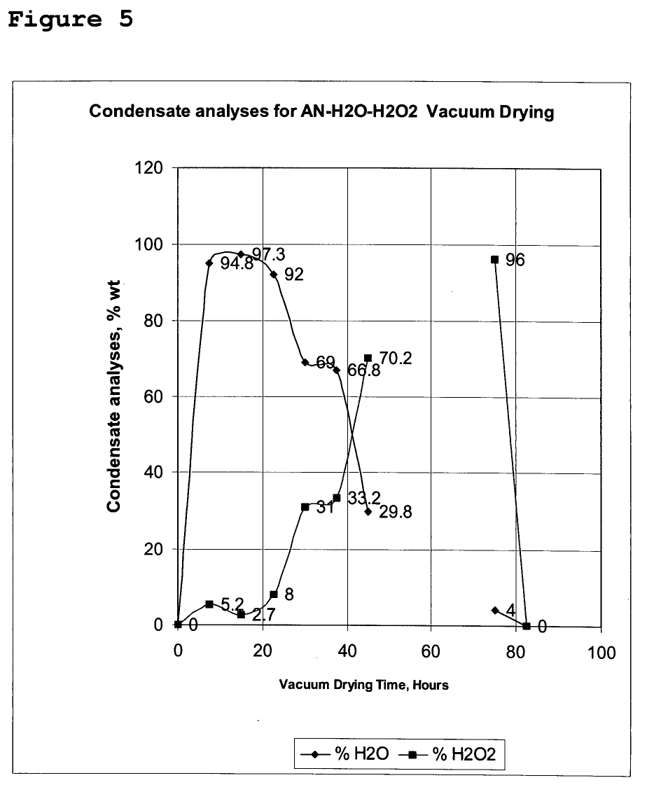

Premixing anhydrous ammonium nitrate with aqueous hydrogen peroxide forms a covalent nitrate-peroxidate, which upon applying heat and/or vacuum will initially result in only water in the distillate and a still pot XNPER residue, with decreasing water content and increasing molecular-adduct hydrogen peroxide content (see FIGS. 4 and 5). As the distillation the distillate's water content decrease and eventually the hydrogen peroxide content increases.

Organic additives to the oxidizers of the invention may be used to form fuel compositions; such additives include alkyl alcohols, or alkyamine nitrate, or organic liquid fuels, such as fuel oil, or polymeric binders. Mixing and subsequent combustion of one or more of the peroxidates of the invention with a poly-halogenated hydrocarbon, such as Viton, Teflon, hexachlorobenzene and the like, will produce halogenated exhaust gas products, which may be used to decontaminate chemical- or biological agent-contaminated areas.

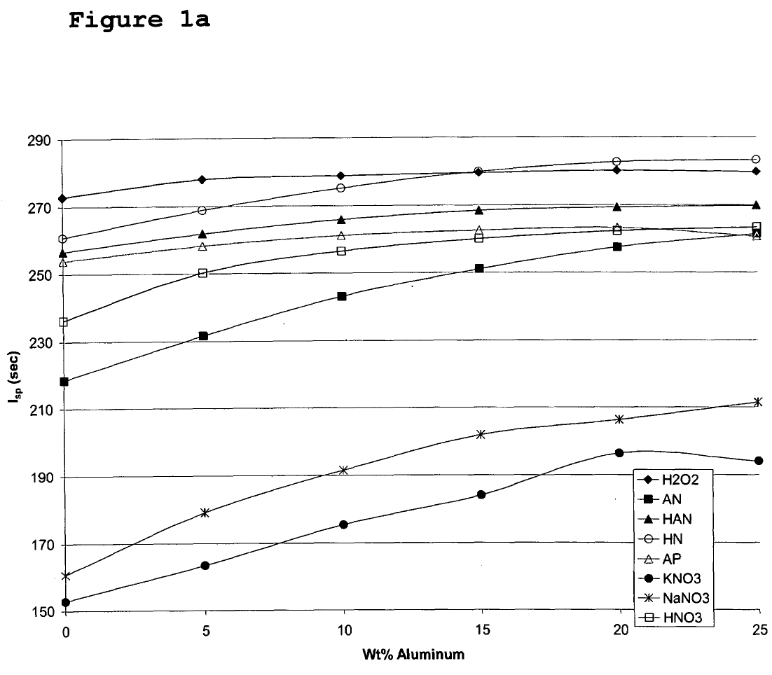

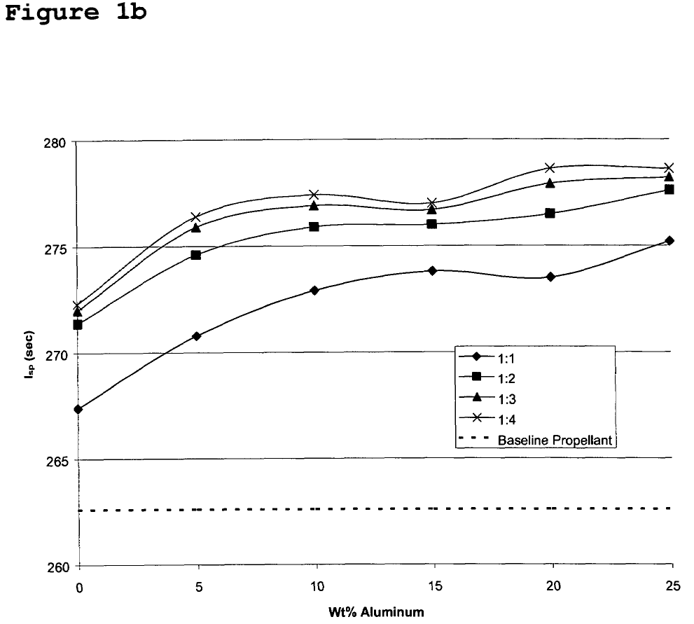

PEP formulators have available a NASA software program, NEWPEP, and other similar software which will predict theoretically the effect on relative performances by changes in oxidizer and fuel formulations. Using the baseline conditions of a standard ammonium perchlorate (AP) solid propellant, consisting of 88% solids loaded HTPB based propellant, substituting in 0 to 25% aluminum and the removing oxidizer, the theoretical performance of the baseline oxidizer, ammonium perchlorate (AP) was compared to various anhydrous solid and liquid oxidizers, and also to various molar ratios ammonium nitrate to hydrogen peroxide peroxidates; the results of this predictive data are shown graphically in FIGS. 1a and 1b.

Based on these two theoretical performance comparison graphs, some anhydrous solid oxidizers outperform ammonium perchlorate; the following is the order of these oxidizers' effectiveness in increasing the combustion energy output: HN>H₂O₂>HAN>HNO3>AP>AN>NaNO₃>KNO₃. The second graph predicts that the 1:1 molar ratio of ammonium nitrate:H₂O₂ outperforms ammonium perchlorate, and higher molar ratios would further increase these combustion energy outputs.

Chemical reactants used in the practice of this invention are preferably anhydrous alkali nitrates, or secondarily, commercially-available concentrated aqueous alkali nitrates, or less desired, made by dissolving anhydrous, solid alkali nitrates, ammonium nitrate, potassium nitrate, sodium nitrate, and/or ammonium dinitramide (“ADN”) in the chosen solvent, preferably water, or most preferably dissolved directly into commercially-available, concentrated 30% aqueous hydrogen peroxide, or still more preferably 70% aqueous hydrogen peroxide. Mixtures of solvents can also be used. Generally, the nitrate compound (sodium nitrate, potassium nitrate or ammonium nitrate) is dissolved in the hydrogen peroxide in combination with a solvent or with gaseous hydrogen peroxide. Lower hydrogen peroxide concentrations increase the time and cost for removing the additional water. After the solid nitrate compound is dissolved in the hydrogen peroxide or exposed to hydrogen peroxide vapors, the corresponding solid peroxidate can be recovered by solvent removal, such as thermal treatment, vacuum treatment, freeze-drying, and freeze crystallization. Further separation and purification of the peroxidate can be achieved through known processes, including column chromatography with silica gel packing and/or using a solvent eluent, such as methylene chloride or ethanol, followed by removal of the solvent content of the eluent by thermal or vacuum treatment, freeze-drying, freeze crystallization.

The most stable chemical form of the chemical adduct is a 1:1 molar adduct of inorganic nitrate and hydrogen peroxide, with other chemical adducts having 1, 2, 3, 4, 5 or 6 moles of hydrogen peroxide per mole of inorganic nitrate. Molar ratios of about 1:1 nitrate:peroxide are preferred for use in commercial applications because of the improved chemical stability inherent in lower molar ratio chemical adducts, although higher molar ratios will be more reactive chemically, and therefore desirable for some applications.

The following tables describe the basic properties of the inorganic nitrate/peroxide complexes:

TABLE 1
Percentages by Weight of Chemical Ingredients in
Ammonium Nitrate Peroxidates (ANPER)

| Moles of H₂O₂ | | | Molecular |
|---|---|---|---|
| per Mole of | % Hydrogen | % Ammonium | Weight of |
| AN | Peroxide | Nitrate | Peroxidate |
| 0.00 | 0 | 100 | 80 |
| 0.25 | 7.45 | 92.55 | 88.5 |
| 0.50 | 14.9 | 85.1 | 97 |
| 1.00 | 29.8 | 70.2 | 114 |
| 2.00 | 45.9 | 54.1 | 146 |
| 3.00 | 56.0 | 44.0 | 180 |

TABLE 2
Percentages by Weight of Chemical Ingredients in
Potassium Nitrate Peroxidates (KNPER)

| Moles of | | | Molecular |
|---|---|---|---|
| H₂O₂ per | % Hydrogen | % Potassium | Weight of |
| Mole of KN | Peroxide | Nitrate | Peroxidate |
| 0.00 | 0 | 100 | 101.1 |
| 0.25 | 7.8 | 92.2 | 109.6 |
| 0.50 | 14.4 | 85.6 | 118.1 |
| 1.00 | 25.2 | 74.8 | 135.1 |
| 2.00 | 40.2 | 59.8 | 169.1 |
| 3.00 | 50.2 | 49.8 | 203.1 |

TABLE 3
Percentages by Weight of Chemical Ingredients in
Sodium Nitrate Peroxidates (SNPER)

| Moles of | | | Molecular |
|---|---|---|---|
| H₂O₂ per | % Hydrogen | % Sodium | Weight of |
| Mole of SN | Peroxide | Nitrate | Peroxidate |
| 0.00 | 0 | 100 | 85 |
| 0.25 | 9.1 | 90.9 | 93.5 |
| 0.50 | 16.7 | 83.3 | 102 |
| 1.00 | 28.6 | 71.4 | 119 |
| 2.00 | 44.4 | 55.6 | 153 |
| 3.00 | 54.5 | 45.5 | 187 |

### EXAMPLES

The following examples are representative of the preparation and characterization of the compounds of the invention.

During the synthesis of the ammonium nitrate/hydrogen peroxide (AN/H₂O₂) Complex, as described in Examples 1 and 2, the distillate and still pot residue were weighed and their hydrogen peroxide contents were determined using the standard permanganate titrimetric analytic procedure. Water content of the distillate was calculated as the difference between 100% and the hydrogen peroxide content. Based on these analytical data, a material balance evaluation of this syntheses was used to determine the molar ratios of hydrogen peroxide to ammonium nitrate (FIGS. 4 and 5). Testing of each compound was carried out by thermogravimetric analysis, differential scanning calorimetry and safety test analysis.

Testing of end-product compounds were carried out by thermogravimetric analysis, differential scanning calorimetry, permanganate titrations, and safety test analysis.

Thermogravimetric analysis measures weight loss upon heating, which could be due to solvent evaporating from a sample, or the result of a partial or a total exothermic decomposition of the sample. Therefore, it is desirable to analyze samples by both thermogravimetric analysis and by differential scanning calorimetry, and then compare these analyses.

Differential Scanning Calorimetric (DSC) analyses use bi-cyclic temperature analyses where the temperature starts initially at ˜25° C., is increased to 200° C., then allowed to cool back to 25° C. During the DSC heating cycle for the inorganic nitrate ingredients, endothermic phase transitions, will appear as exothermic phase transitions at approximately the same temperature on the cool down cycle. Alterations in the sizes or locations of these endotherms or the exotherms, is due to the chemical interactions or the covalent-bonding between the inorganic nitrate and the hydrogen peroxide.

During the heating cycle, the temperature at which a downward, endothermic peak is recorded could indicate either a crystalline phase transition or a solvent evaporation; an upward, exothermic peak could indicate a non-reversible decomposition of the sample. During cool down, no exotherm would be indicated at temperature where endothermic solvent evaporations occurred. If an exotherm were observed on cool down, this could indicate a reversed shifting of the sample's crystalline phase transition.

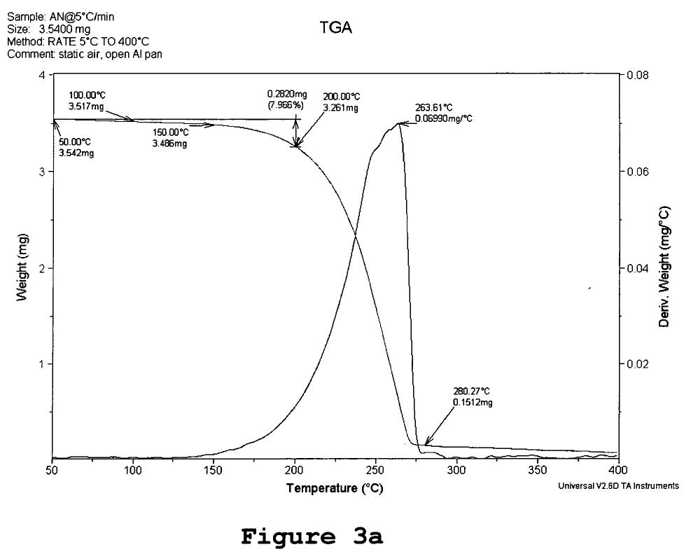

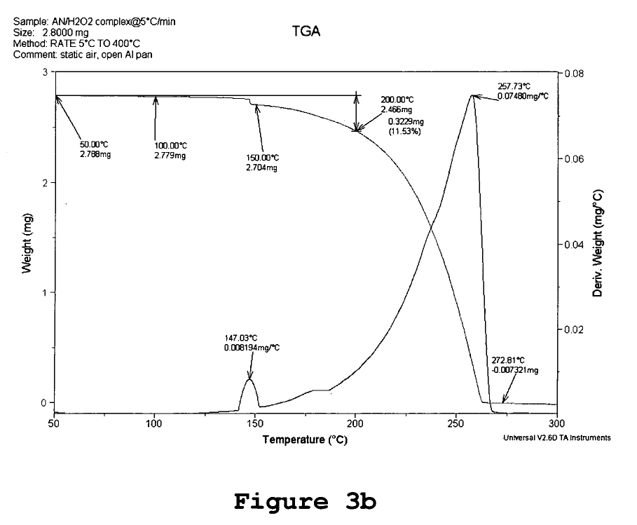

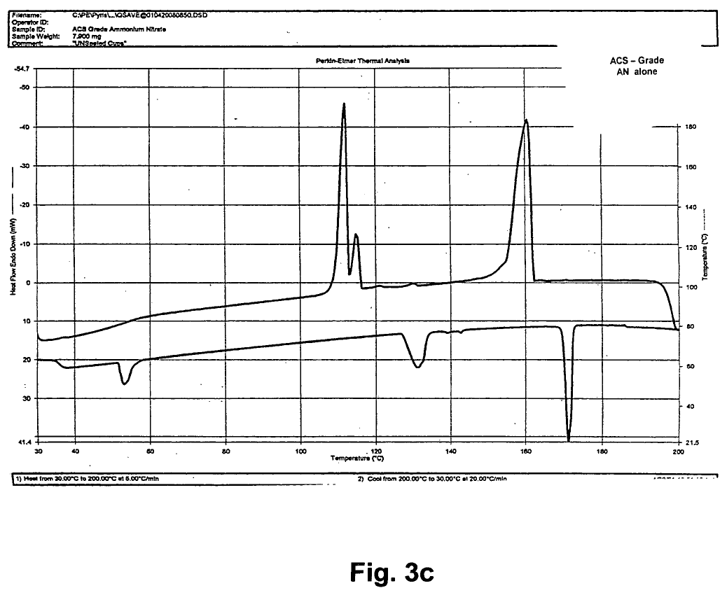

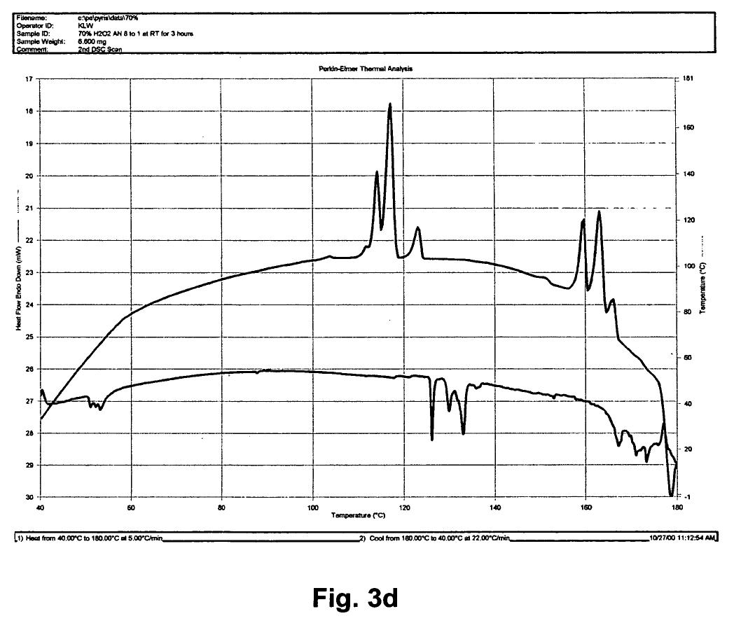

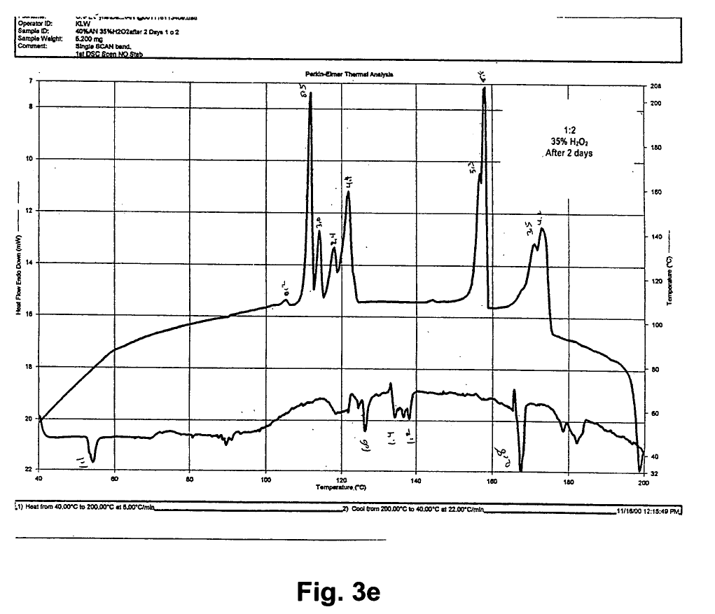

An additional benefit of DSC evaluations of XNPERs becomes evident by comparing the DSC analyses of baseline AN (FIG. 3c) with XNPERs made by reacting AN with varying concentrations of hydrogen peroxide, such as 70% and 35% (FIGS. 3d and 3e, respectively). The relative positions and sizes of the endotherms and exotherms, as shown in these three figures indicate the formation of several, different poly-peroxidates.

Safety test analyses are standard US Department of Defense tests, including impact, sliding friction, and electrostatic discharge.

### Example 1

### Ammonium Nitrate/Hydrogen Peroxide (AN/H₂O₂) Complex

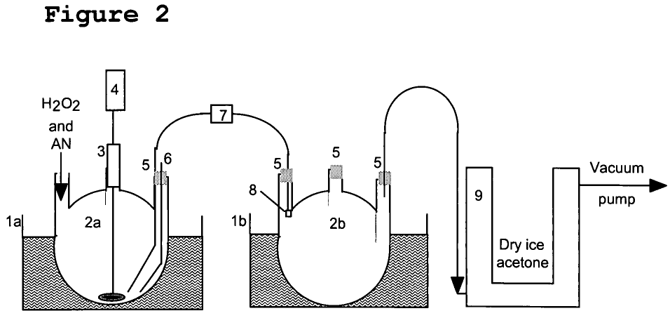

An ammonium nitrate/hydrogen peroxide complex was prepared using the equipment shown in FIG. 2, including temperature controlled water bath 1, 3-neck flask 100, 250, 500-mL 2, bearing 3, air motor 4, stopper 5, thermocouple 6, valve 7, spray nozzle 8, and dry ice trap 9.

Hydrogen peroxide (117 grams 30%, 1.03 moles) was added to a 250-mL 3-neck flask (2a). Ammonium nitrate (25 grams, 0.31 moles) was added to the stirred hydrogen peroxide at 21° C. The temperature dropped to 18° C. and then to 15° C. when all the ammonium nitrate was dissolved. The water bath (1b) was heated to 40° C. and flask (2b) was evacuated to less than 1 Torr of vacuum. Valve (7) was opened and solution was evaporated. Valve (7) was closed and the last traces of water were removed. The water distillate contained traces of hydrogen peroxide.

55.1 grams (54% weight gain) of coarse white crystals were obtained.

NSWC/IH AN/(H₂O₂) Sensitivity Data:

NOS impact (5 kg) 50%>1000 mm (RDX 272 mm,)

Friction sensitivity (BAM)>360 Newtons

ESD sensitivity is 0.326 joules

The TGA of the AN/H₂O₂ complex was run with a heating rate of 5°/minute to 400° C., as shown in FIG. 3b, with comparison to ammonium nitrate in FIG. 3a. The sample appeared dry at about 150° C.; there was weight lost.

The DSC of the AN/H₂O₂ complex was run with a heating rate of 5°/minute to 200° C. and cooling to 20° C. at about 5°/minute as shown in FIGS. 3d and 3e (compared with ammonium nitrate in FIG. 3c). On heating the four endotherms occur at:

53.94° C. 19.41 Joules/gram

90.73° C. 14.78 Joules/gram

130.82° C. 41.84 Joules/gram

161.11° C. 40.64 Joules/gram

On cooling the three exotherms occur at:

154.13° C. 51.73 Joules/gram

118.69° C. 46.12 Joules/gram

44.97° C. 20.49 Joules/gram

### Example 2

### Ammonium Nitrate/Hydrogen Peroxide (AN/H₂O₂) Complex

The ammonium nitrate/hydrogen peroxide complex was prepared using the equipment shown in FIG. 2. Hydrogen peroxide (117 grams 30%, 1.03 moles) was added to a 250-mL 3-neck flask (2a). Ammonium nitrate (AN) (25 grams, 0.31 moles) was added to the stirred hydrogen peroxide at 10° C. The temperature dropped to −2° C. and then to 15° C. when all the AN was dissolved.

Synthesis steps are summarized in Table 4, below:

TABLE 4
Synthesis of Ammonium nitrate Peroxidate:
Condensate Composition

| | | | |
|---|---|---|---|
| Initial | Hydrogen Peroxide | 35.1 | 1.03 moles |
| reactants: | | grams | |
| | Ammonium Nitrate | 25 grams | 0.3 moles |
| | H2O2/AN molar ratio | | 3.3 |
| | Heat of Solution, C. | −2 | |
| | degrees | | |
| Evaporation | 70–80 | | |
| time, hours | | | |
| Still Pot | 0–25 | | |
| temperature | | | |
| ° C. | | | |
| Vacuum, mmHg | 15–40 | | |
| Heat of | −2 | | |
| Solution ° C. | | | |

| | | % recovery of Initial | | Condensate | |
|---|---|---|---|---|---|
| Evaporation | | Solvents | | Analysis | |
| Time, hours | H2O2: AN molar ratio | % H2O | % H2O2 | % H2O | % H2O2 |
| 0 | 3.32 | 0 | 0 | 0 | 0 |
| 7.5 | 3.26 | 14.3 | 1.7 | 94.8 | 5.2 |
| 15 | 3.16 | 72.8 | 5.4 | 97.3 | 2.7 |
| 22.5 | 3.03 | 90.4 | 9.1 | 92 | 8 |
| 30 | 2.81 | 97 | 15.6 | 69 | 31 |
| 37.5 | 2.61 | 102 | 21.4 | 66.8 | 33.2 |
| 45 | 2.45 | 103 | 26.5 | 29.8 | 70.2 |
| 52.5 | | | | | |
| 60 | (Syrup) | | | | |
| 67.5 | | | | | |
| 75 | 1.55 (Solid) | 103 | 53.6* | 4 | 96 |
| 82.5 | | | *includes HP | 0 | 0 |
| | | | in ANPER | | |

Each distillate cut was 7 to 8 hours of vacuum drying. Results are set forth in Table 5, below:

TABLE 5
Distillation of AN/H₂O₂ Complex

| Distillate | Temp | Vacuum | Distillate | Distillate | AN/H₂O₂ |
|---|---|---|---|---|---|
| No. | (° C.) | (μm of Hg) | (grams) | (% H₂O₂) | (grams) |
| 1 | 35 | 12.3 | 5.2 | | |
| 2 | 10–15 | 35 | 49.2 | 2.7 | |
| 3 | 13 | 35 | 15.7 | 8.0 | |
| 4 | 15 | 20 | 7.8 | 31 | |
| 5 | 13 | 20 | 5.8 | 33.2 | |
| 6 | 15 | 15 | 2.5 | 70.2 | |
| 7 | 13 | 20 | 1 | | |
| 8 | 15 | 40 | 0.5 | | 42.3* |
| 9 | 15 | 40 | 0.5 | | |
| 10 | 25 | 40 | 9.9 | 96 | 26.3** |

*viscous liquid with 50% H₂O₂
**26.3 grams of ANPER product with 7.0% H₂O₂

Results are shown in FIGS. 4 and 5.

### Example 3

### Potassium Nitrate/Hydrogen Peroxide (KNO₃/H₂O₂) Complex

Using the equipment as described, 37 grams of 30% hydrogen peroxide (0.326 moles, 10% excess) was added to a 100-mL 3-neck flask (2a). Potassium nitrate (10 grams 0.099 moles) was added to the stirred hydrogen peroxide at 22° C. The temperature dropped to 20° C. After removal of the water 10.41 grams remained. Most of the complex decomposed during the 40° C. heating-vacuum drying.

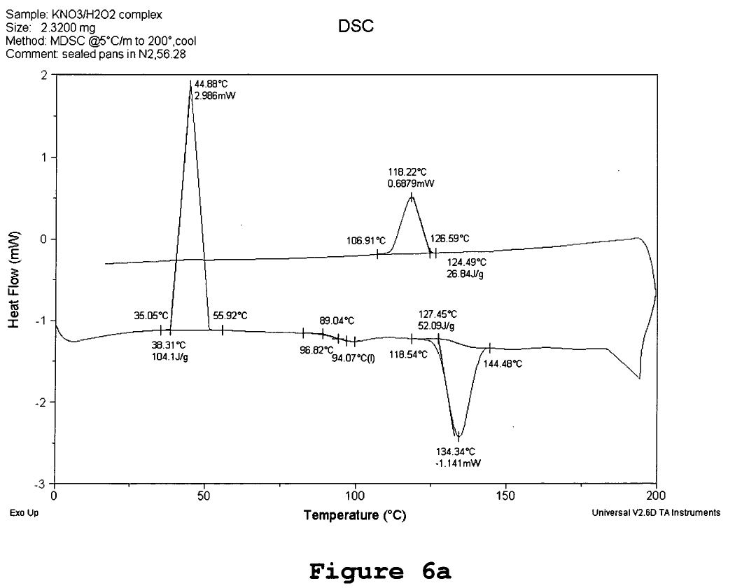

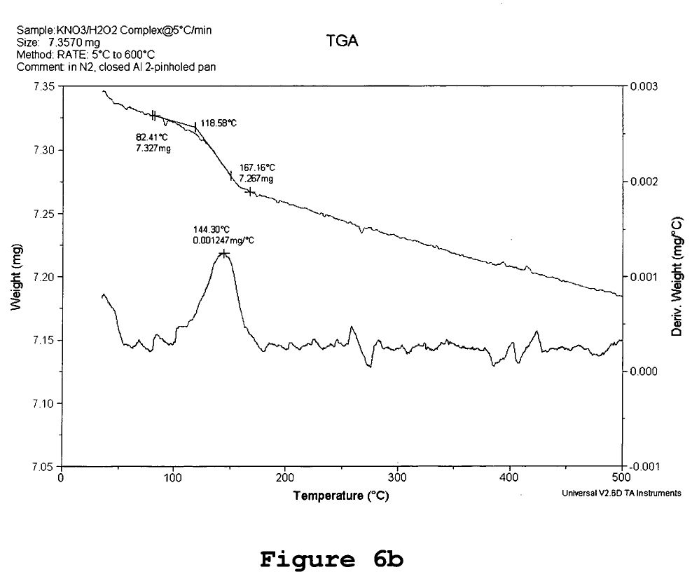

Analyses of the complex by differential scanning calorimetry and thermgravimetric analysis are shown, respectively, in FIGS. 6a and 6b.

### Example 4

### Sodium Nitrate/Hydrogen Peroxide (NaNO₃/H₂O₂) Complex

Using the equipment as described, 44 grams of 30% hydrogen peroxide (0.388 moles) was added to 100-mL 3-neck flask (2a). Sodium nitrate (10 grams 0.118 moles) was added to the stirred hydrogen peroxide at 21° C. The temperature dropped to 19° C. After removal of the water 9.91 grams remained. Most of the complex decomposed during the 40° C. heating-vacuum drying.

### Example 5

### Column Chromatography: Purification and Separation of Peroxidates

The initial aqueous solution of feed stock or the anhydrous peroxidate product of Examples 1, 2 and 3 was fed to a glass column packed with silica gel pre-wetted with dichloromethane, followed by additional aliquots of dichloromethane and a final column rinse of either methanol or ethanol. The eluent product cuts were dried with heat and/or vacuum to isolate the starting inorganic nitrate-salt from its poly-peroxidates: (mono- or di- or tri-peroxidates).

### Example 6

### Freeze Crystallization Points of Inorganic Nitrates in Hydrogen Peroxide Solutions

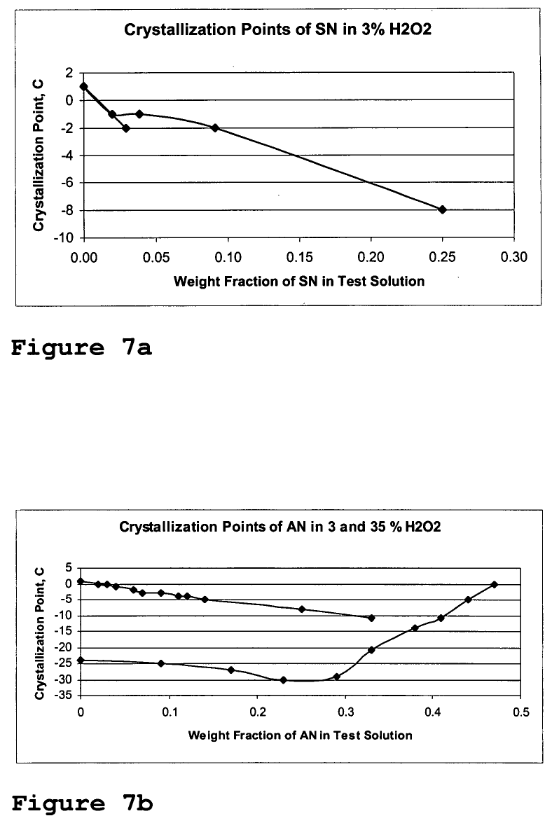

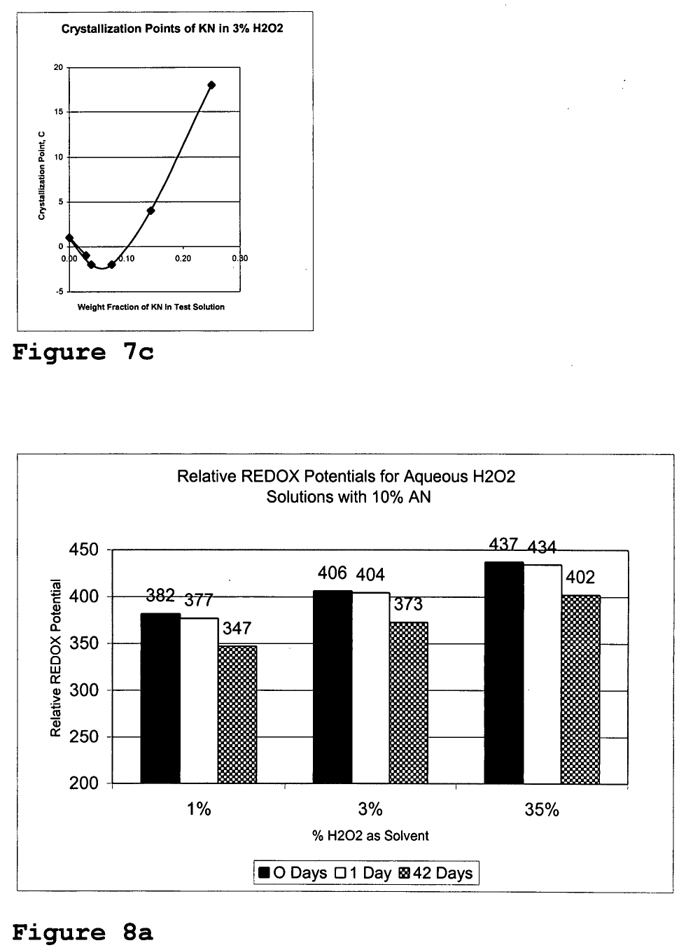

The crystallization points of ammonium nitrate, sodium nitrate and potassium nitrate in 3% hydrogen peroxide, and the crystallization points of ammonium nitrate in 35% hydrogen peroxide were experimentally determined and set forth in the tables below, and in FIGS. 7a, 7b, and 7c.

TABLE 6
Crystallization Points Crystallization Points for
Weight Fractions of AN, KN, and SN in 3% H₂O₂

| Nitrate | | | | Crystallization Pt, |
|---|---|---|---|---|
| added | Nitrate | HP | Water | ° C. |
| KN | 0.00 | 0.03 | 0.97 | 1 |
| KN | 0.03 | 0.03 | 0.94 | −1 |
| KN | 0.00 | 0.03 | 0.97 | 1 |
| KN | 0.04 | 0.03 | 0.93 | −2 |
| KN | 0.07 | 0.03 | 0.90 | −2 |
| KN | 0.14 | 0.03 | 0.83 | 4 |
| KN | 0.25 | 0.02 | 0.73 | 18 |
| SN | 0.00 | 0.03 | 0.97 | 1 |
| SN | 0.03 | 0.03 | 0.94 | −2 |
| SN | 0.00 | 0.03 | 0.97 | 1 |
| SN | 0.02 | 0.03 | 0.95 | −1 |
| SN | 0.04 | 0.03 | 0.93 | −1 |
| SN | 0.09 | 0.03 | 0.88 | −2 |
| SN | 0.25 | 0.02 | 0.73 | −8 |
| AN | 0.00 | 0.03 | 0.97 | 1 |
| AN | 0.03 | 0.03 | 0.94 | 0 |
| AN | 0.02 | 0.03 | 0.95 | 0 |
| AN | 0.04 | 0.03 | 0.93 | −1 |
| AN | 0.06 | 0.03 | 0.92 | −2 |
| AN | 0.07 | 0.03 | 0.90 | −3 |
| AN | 0.09 | 0.03 | 0.88 | −3 |
| AN | 0.11 | 0.03 | 0.87 | −4 |
| AN | 0.12 | 0.03 | 0.85 | −4 |
| AN | 0.14 | 0.03 | 0.84 | −5 |
| AN | 0.25 | 0.02 | 0.73 | −8 |
| AN | 0.33 | 0.02 | 0.65 | −11 |

TABLE 7
Crystallization Points of AN in 3% and 35% Hydrogen
Peroxide

| | | | Crystallization |
|---|---|---|---|
| AN | HP | Water | Pt, ° C. |
| 0.00 | 0.35 | 0.65 | −24 |
| 0.09 | 0.32 | 0.59 | −25 |
| 0.17 | 0.29 | 0.54 | −27 |
| 0.23 | 0.27 | 0.50 | −30 |
| 0.29 | 0.25 | 0.46 | −29 |
| 0.33 | 0.23 | 0.43 | −21 |
| 0.38 | 0.22 | 0.41 | −14 |
| 0.41 | 0.21 | 0.38 | −11 |
| 0.44 | 0.19 | 0.36 | −5 |
| 0.47 | 0.18 | 0.34 | 0 |
| 0.00 | 0.03 | 0.97 | 1 |

TABLE 8
Crystallization Points of AN in 3% and 35% Hydrogen
Peroxide

| | | | Crystallization |
|---|---|---|---|
| AN | HP | Water | Pt, ° C. |
| 0.00 | 0.35 | 0.65 | −24 |
| 0.09 | 0.32 | 0.59 | −25 |
| 0.17 | 0.29 | 0.54 | −27 |
| 0.23 | 0.27 | 0.50 | −30 |
| 0.29 | 0.25 | 0.46 | −29 |
| 0.33 | 0.23 | 0.43 | −21 |
| 0.38 | 0.22 | 0.41 | −14 |
| 0.41 | 0.21 | 0.38 | −11 |
| 0.44 | 0.19 | 0.36 | −5 |
| 0.47 | 0.18 | 0.34 | 0 |
| 0.00 | 0.03 | 0.97 | 1 |

### Example 7

### Relative Chemical Reactivity

Chemical reactivity of Hydrogen Peroxide decreases with its water content: (anhydrous HP, VPHP)>(Low Water Content Hydrogen Peroxide, LWHP)>than higher water content aqueous Hydrogen Peroxide. Relative Reduction-Oxidation (REDOX) potential measurements of reactive chemicals are used as a means to predict relative reactivity.

Table 9, below, provides experimental data showing relative REDOX values, with the samples representing a time study up to 42 days to determine storage time effect on relative REDOX potentials; this data is plotted in FIGS. 8a-8c.

Reactions with these enhanced peroxidate adducts will consume the hydrogen peroxide group in hydroxylations, epoxidations, etc; however, as is shown in the experimental relative REDOX data, addition of replacement concentrated (30% to 70%) hydrogen peroxide will rejuvenate the spent inorganic nitrate peroxidate's reactivity. Environmentally, this is desirable since the base nitrate salt is recycled to enhance the hydrogen peroxide for additional reactions.

TABLE 9
Relative REDOX Potentials for Aqueous XNPER solutions
PERSOL 1 and K REDOX Values

| | Sample age, days | | |
|---|---|---|---|
| Test Mixture | 0 | 1 | 42 |
| 0% HP | 279 | 253 | 190 |
| 0% HP/5% AN | | | 280 |
| 0% HP/10% AN | | | 279 |
| 0% HP/20% AN | | | 288 |
| 0% HP/5% KN | | | 300 |
| 0% HP/5% KN | | | 300 |
| 0% HP/10% KN | | | 291 |
| 0% HP/20% KN | | | 293 |
| 1% HP | 279 | 253 | 262 |
| 1% HP/5% AN | 373 | 386 | 357 |
| 1% HP/10% AN | 370 | 377 | 355 |
| 1% HP/20% AN | 376 | 380 | 353 |
| 1% HP/5% KN | 368 | 370 | 341 |
| 1% HP/10% KN | 382 | 377 | 347 |
| 1% HP/20% KN | 388 | 385 | 353 |
| 3% HP | 435 | 428 | 330 |
| 3% HP/5% AN | 393 | 409 | 387 |
| 3% HP/10% AN | 389 | 397 | 376 |
| 3% HP/20% AN | 394 | 402 | 377 |
| 3% HP/5% KN | 401 | 401 | 379 |
| 3% HP/10% KN | 406 | 404 | 373 |
| 3% HP/20% KN | 407 | 407 | 381 |
| 35% HP | 485 | 494 | 410 |
| 35% HP/5% AN | 421 | 424 | 397 |
| 35% HP/10% AN | 411 | 415 | 402 |
| 35% HP/20% AN | 412 | 415 | 387 |
| 35% HP/5% KN | 443 | 440 | 412 |
| 35% HP/10% KN | 437 | 434 | 402 |
| 35% HP/20% KN | 436 | 433 | 394 |

Summary of DSC Analyses:

As the molar ratio of inorganic nitrate to hydrogen peroxide increases from 1:1 to 1:2 or greater, the chromatograms change greatly due to the formation of not only mono-peroxidates, but also, di-peroxidates. AN poly-peroxidates have different phase transitions versus baseline ammonium nitrate. Potassium nitrate mono-peroxidate showed an unexpected major exotherm at ˜45° C., and a major endotherm ˜134° C.

### Safety Test Analyses:

All three inorganic nitrate mono-peroxidates were inert on various DOD-standardized safety tests: impact, sliding friction, and electrostatic discharge.

### Thermogravimetric Analysis (TGA):

AN Mono-peroxidate was thermally stable to >145° C.

KN Mono-peroxidate was thermally stable to ˜145° C.

SN Mono-peroxidate was thermally stable to ˜40° C., then 145° C.

Peroxidates release their Hydrogen Peroxide groups stepwise.

### Example 8

### Proposed Compositions

The following compositions utilize the nitrate-peroxidate oxidizers (XNPER) of the invention.

Propellant:

| No. | Ingredient | Purpose | Weight % range | preferred |
|---|---|---|---|---|
| 1 | HTPB | Binder/Fuel | 2–49 | 20 |
| | Al | Fuel | 2–49 | 20 |
| | Iron Compound | combustion | 0.1–6 | 2 |
| | | catalyst | | |
| | XNPER | oxidizer | 50–90 | 58 |
| 2 | polysulfide rubber | Binder/fuel | 20–40 | 20 |
| | XNPER | oxidizer | 50–80 | 80 |

Pyrotechnic:

| | Ingredient | Purpose | Weight % range | Preferred |
|---|---|---|---|---|
| 1 | Silicone rubber | Binder | 10–25 | 15 |
| | XNPER | Oxidizer | 4–80 | 75 |
| | Copper oxide | Colorant | 0–15 | 10 |
| 2 | Silicone Rubber | Binder | 10–25 | 15 |
| | XNPER | Oxidizer | 4–80 | 75 |
| | Barium Sulfate | Colorant | 0–20 | 15 |

Explosive:

| No. | Ingredient | Purpose | Weight % range | Preferred |
|---|---|---|---|---|
| 1 | HTPB | Binder/Fuel | 10–30 | 20 |
| | XNPER | Oxidizer | 10–60 | 60 |
| | Al | Fuel | 5–25 | 20 |
| | RDX | Energetic Fuel | 5–15 | 5 |
| 2 | XNPER | Oxidizer | 10–40 | 35 |
| | TNT | Energetic Fuel | 10–40 | 25 |
| | RDX | Energetic Fuel | 5–25 | 20 |
| | Al | Fuel | 10–40 | 20 |

In the above compositions:
Al = Aluminum, added to increase energy output; Iron Compound is a burning rate catalyst, for example Fe₂O₃;
HTPB = Hydroxy-terminated Poybutadiene, a rubbery-binder;
XNPER = ANPER, KNPER, SNPER, or combination thereof;
RDX = Cyclomethylenetrinitramine; and
TNT = Trinitrotoluene.

Concentrated Hydrogen Peroxide can be produced directly from the inorganic nitrate peroxidates by partial or total dissolution in an inorganic or in an organic solvent. This solvent-peroxidate mixture can also be used as a chemical reactant medium.

Vacuum evaporation and freeze concentration of Water-Hydrogen Peroxide mixtures to manufacture very concentrated Hydrogen Peroxide is safer, faster, and more energy-efficient with an initial addition of anhydrous inorganic nitrates to the Aqueous Hydrogen Peroxide, since the inorganic nitrate will reduce HP's vapor pressure (volatility), retaining the inorganic nitrate-HP in the still pot bottoms.

Thermal evaporation with or without vacuum of the Water-Hydrogen Peroxide mixtures to manufacture very concentrated Hydrogen Peroxide is faster and more energy-efficient with an initial addition of anhydrous inorganic nitrates to the Aqueous, preferably concentrated, Hydrogen Peroxide, since the inorganic nitrate reduces HP's vapor pressure (volatility), by initially bonding the Hydrogen Peroxide to the inorganic nitrate, thereby retaining, the inorganic nitrate-HP in the still pot bottoms; initially allowing for distilling off the of the water, then a water-Hydrogen Peroxide distillation cut (LWHP), and finally a concentrated Vapor Phase Hydrogen Peroxide cut, leaving a still pot product of the anhydrous solid or liquid Inorganic Nitrate-Hydrogen Peroxide.

Ammonium Nitrate follows the above processing, whereas Potassium Nitrate (KN) and Sodium Nitrate (SN) have lower covalent bonding strengths, releasing the hydrogen peroxide more easily. Therefore, to manufacture KN and SN peroxidates, milder water removal processes must be used, such as column chromatography, freeze concentration, or freeze drying. However, after the water content is lowered for these two peroxidate-water mixture, LWHP can be recovered more easily.

After distilling off the water, vapor phase concentrated and/or anhydrous Hydrogen Peroxide can be produced directly from this initial inorganic nitrate peroxidate-water mixture by applying reduced pressure and/or heat.

Concentrated or anhydrous liquid or solid Inorganic Nitrate-Hydrogen Peroxide can be produced directly from the initial inorganic nitrate-Hydrogen Peroxide-Water mixture by various drying processes, such the aforementioned thermal-vacuum drying, spray drying, freeze drying, or freeze crystallization (concentration) without or with vacuum (lyophilization), or by column chromatography.

An inorganic nitrate-aqueous Hydrogen Peroxide mixture can be energy-efficiently, pre-concentrated by freeze crystallization (concentration), prior to the final water removal drying. Alternatively, liquid chromatography has been shown to separate and concentrate these inorganic nitrate peroxidates.

Vacuum evaporation of Water-Hydrogen Peroxide mixtures to manufacture very concentrated Hydrogen Peroxide is faster, more energy-efficient, by the exothermic addition of one of the anhydrous inorganic nitrates to the aqueous Hydrogen Peroxide, since:

1. the amount of water needed to be removed is minimized;

2. the inorganic nitrate will reduce vapor pressure of the hydrogen peroxide, retaining the inorganic nitrate-HP in the still pot bottoms,

3. after most of the water has been distilled off, vapor phase concentrated hydrogen peroxide can be recovered by distillation.

4. distillation to a dry still pot bottoms, yields the solid or liquid XNPERs.

Apparent Peroxidate Bonding Strength in XNPERs:

Some inorganic nitrate poly-peroxidates may have weaker and/or more unstable covalent bonding, causing increased cleaving of peroxidate groups when temperature, vacuum, and other driving forces are increased. In the case of the ANPERs, ease of peroxidate cleavage is lowered indirectly with the number of peroxidate groups on the ANPER molecule. SNPER and KNPER lose most of their peroxidate groups in the vacuum drying of their chemical synthesis. Also, based on thermal analyses, using thermogravimetric analyses (TGA), temperatures less than 50° C. cleave their peroxidate group; whereas ANPER's TGAs lose their peroxidate about 145° C. This low temperature cleavage of SNPER's and SNPER's may be beneficial in producing low water content Hydrogen Peroxide (LWHP) and/or Vapor Phase Hydrogen Peroxide (VPHP).

Anhydrous nitrate-peroxidate adducts, will crystallize or form liquids or solids in definite molar ratios of inorganic nitrate salt to hydrogen peroxide, most preferred being 1:1, although the liquid 1:2 adducts and other molar ratios of anhydrous chemical adducts or blends thereof can form; the lower molar 1:1 molar ratios will be solids, with better thermal stability than the 1:2 or higher molar ratios. Admixtures of one or more nitrate peroxidates may be desirable to obtain more end-products with more desirable physical or chemical properties.

Increased Crystal Densities:

Based on other peroxidates' crystal density increasing with increased molar ratios of HP, the inorganic nitrate peroxidates will have higher crystal densities than the base inorganic nitrate crystals. Higher crystal densities are desirable in developing energetic formulations.

Enhanced Chemical Reactivity:

Chemical reactivity of anhydrous hydrogen peroxide is greater than aqueous hydrogen peroxide, even concentrated HPs. Addition of inorganic nitrates to hydrogen peroxide solutions increases the solutions' REDOX potential, which is a predictive measurement of its chemical reactivity.

What is claimed is:

1. A substantially anhydrous solid or liquid chemical adduct comprising:
hydrogen peroxide; and
a compound selected from the group consisting of sodium nitrate, potassium nitrate, ammonium nitrate, ammonium dinitramide and mixtures thereof.

2. The adduct of claim 1, containing, by weight, 44% to 70.2% ammonium nitrate and 56% to 29.8% hydrogen peroxide.

3. The adduct of claim 1, containing, by weight, 49.8% to 74.8% potassium nitrate and 50.2% to 25.2% hydrogen peroxide.

4. The adduct of claim 1, containing, by weight, 45.5% to 71.4% sodium nitrate and 54.5 to 28.6% hydrogen peroxide.

5. The adduct of claim 1, further comprising a surfactant.

6. The adduct of claim 1, further comprising a stabilizer.

7. A method for forming a substantially anhydrous solid or liquid chemical adduct, comprising the steps of:
providing a nitrate selected from the group consisting of sodium nitrate, potassium nitrate and mixtures thereof; and
reacting the nitrate compound with the hydrogen peroxide to form the adduct.

8. The method of claim 7, further comprising applying heat and/or vacuum to the adduct to synthesize a distillate of aqueous hydrogen peroxide and a still pot bottoms of said substantially anhydrous adduct.

9. The method of claim 7, further comprising applying freeze crystallization and/or vacuum to the adduct to synthesize a distillate or filtrate of aqueous hydrogen peroxide and a still pot bottoms or a filter cake of said substantially anhydrous adduct.

10. The method of claim 7, further comprising treating the adduct by column chromatograhy to synthesize aqueous hydrogen peroxide, and a solvent eluent which upon evaporation of the solvent produces said substantially anhydrous adduct.

11. Method of claim 7, further comprising application of heat and/or vacuum to the substantially anhydrous adduct to synthesize anhydrous vapor phase hydrogen peroxide (VPHP).

12. Method for carrying out a hydroxylation, epoxidation, or biodecontamination reaction comprising adding to a reaction mixture a nitrate-peroxidate adduct prepared according to claim 7 as a hydroxylation, epoxidation or biodecontamination reactant.

13. Method of claim 12, wherein the oxidizer is an aqueous solution of the nitrate-peroxidate adduct, resulting in a spent aqueous nitrate-peroxidate solution

14. Method of claim 13, additionally comprising rejuvenating the spent solution by addition of concentrated hydrogen peroxide.

15. A propellant, explosive, or pyrotechnic formulation, comprising as an oxidizer the adduct of claim 1.

16. The composition of claim 15, which is a propellant comprising, by weight, 2-49% hydroxy-terminated polybutadiene binder, 2-49% aluminum powder, 0.1-6% combustion catalyst, and 50-90% of said adduct.

17. The composition of claim 15, which is a pyrotechnic composition comprising, by weight, 10-25% silicone rubber, 4-80% of said adduct and a colorant compound.

18. The composition of claim 15, which is an explosive composition comprising, by weight, 10-30% hydroxy-terminated polybutadiene binder, 10-60% of said adduct, 5-25% aluminum powder and 5-15% cyclomethylenetrinitramine.
